(19) United States
(12) Patent Application Publication
(10) Pub. No.: US 2020/0227746 A1
(43) Pub. Date: Jul. 16, 2020

(54) NEGATIVE ELECTRODE ACTIVE MATERIAL FOR SECONDARY BATTERY, AND SECONDARY BATTERY

(71) Applicant: SHOWA DENKO K.K., Tokyo (JP)

(72) Inventors: Xu WANG, Minato-ku, Tokyo (JP); Ayaka IKADO, Minato-ku, Tokyo (JP); Akihisa TONEGAWA, Minato-ku, Tokyo (JP); Yasuaki WAKIZAKA, Minato-ku, Tokyo (JP)

(73) Assignee: SHOWA DENKO K.K., Tokyo (JP)

(21) Appl. No.: 16/637,430

(22) PCT Filed: Aug. 8, 2018
(86) PCT No.: PCT/JP2018/029761

§ 371 Date: Feb. 7, 2020

(30) Foreign Application Priority Data
Aug. 8, 2017 (JP) 2017-153044

(51) Int. Cl. H01M 4/587; H01M 10/0525; H01M 4/36; C01B 32/21

(52) U.S. Cl. CPC H01M 4/587; H01M 10/0525; H01M 2004/027; C01B 32/21; H01M 4/364

(57) ABSTRACT

A negative electrode active material for a secondary battery including an artificial flake graphite A and an artificial lump graphite B and having a ratio D_{50(A)}/D_{50(B)} of 50% particle diameter D_{50(A)} of the artificial flake graphite A in a volume-based particle size distribution to 50% particle diameter D_{50(B)} of the artificial lump graphite B in a volume-based particle size distribution is more than 0.6 and less than 1.0. The artificial flake graphite A has a surface roughness R of not less than 2.8 and not more than 5.1, the artificial lump graphite B has a surface roughness R of not less than 6.0 and not more than 9.0, and a ratio B/(A+B) of a mass of the artificial lump graphite B to the total mass of the artificial flake graphite A and the artificial lump graphite B is not less than 0.03 and not more than 0.30.

### TECHNICAL FIELD

The present invention relates to a negative electrode active material suitable for providing a secondary battery excellent in large current load characteristics and direct current resistance characteristics and a secondary battery comprising the negative electrode active material used therein.

### BACKGROUND ART

A lithium ion secondary battery usually comprises a lithium salt, such as lithium cobaltate, which is used as a positive electrode active material, and a carboneous material, such as graphite, which is used as a negative electrode active material. The classification of graphite is fallen into natural graphite and artificial graphite. However, a secondary battery produced using a conventional negative electrode active material made of natural graphite or artificial graphite has a low charge and discharge rate or low rate characteristics, so that the secondary battery is unable to satisfy large current load characteristics and direct current resistance characteristics, which have been strongly demanded in recent years.

Natural graphite has an advantage of being available at a low cost. However, the surface of the natural graphite is active, and hence a large amount of gas is generated during initial charge, which decreases an initial efficiency and results in poor cycle characteristics. Furthermore, natural graphite is in a flake shape, and thus is aligned in one direction when processed into an electrode. When the electrode is charged, the electrode expands only in one direction, which degrades the performance of the electrode. Moreover, the resulting charge and discharge rate is also low.

Artificial graphite is also available at a relatively low cost. Typical examples of artificial graphite can include graphitized products made from petroleum pitch, coal pitch, petroleum coke, or coal coke. However, as one of artificial graphites, artificial graphite made from high crystallinity needle coke tends to align in a flake shape. Thus the resulting rate characteristics are low.

In such a technical background, various negative electrode materials for secondary batteries have been proposed.

For example, Patent Document 1 discloses a carbon material for an electrode, wherein the (002) plane has a surface interval (d002) of less than 0.337 nm and the crystallite size (Lc) is not less than 90 nm as determined by a wide angle X-ray diffraction method, R value, which is a ratio of the peak intensity at 1360 cm⁻¹ relative to the peak intensity at 1580 cm⁻¹ in an argon ion laser Raman spectrum, is not less than 0.20, and a tap density is not less than 0.75 g/cm³. The carbon material for an electrode may be obtained by a production method comprising a mechanical energy treatment decreasing particle sizes so that a ratio of particle sizes before and after the treatment is not more than 1, increasing a tap density, and increasing an R value, which is a ratio of the peak intensity at 1360 cm⁻¹ to the peak intensity at 1580 cm⁻¹ in the argon ion laser Raman spectrum, by not less than 1.5 times.

Patent Document 2 discloses a negative electrode for a lithium secondary battery, wherein a negative electrode active material of lithium metal or lithium ion is supported by a spherical carbon material such as graphitized meso-carbon microbeads.

Patent Document 3 discloses graphite particles to be used for producing a negative electrode for a lithium secondary battery, wherein the graphite particles have an aspect ratio of 1.2 to 5, and a mixture prepared by integrating a mixture of the graphite particles and an organic binder with a current collector has a density of 1.5 to 1.9 g/cm³.

Patent Document 4 discloses a carbonaceous material for an electrode of a nonaqueous solvent-based secondary battery, which has an average surface interval of a (002) plane of not less than 0.365 nm as determined by X-ray diffraction method, wherein a carbonaceous substance that remains after the reaction of the carbonaceous material in a flow of equimolar mixed gas of H₂O and N₂ at 900° C. until a decrease in weight reaches 60% exhibits an average surface interval of the (002) plane of not more than 0.350 nm as determined by X-ray diffraction method.

Patent Document 5 discloses a negative electrode for a nonaqueous electrolytic solution-based secondary battery, wherein the negative electrode comprises a negative electrode current collector and a negative electrode active material layer formed on the negative electrode current collector, and the negative electrode active material layer contains flake graphite formed by graphitization of needle coke, granular graphite formed by graphitization of coke, and a binder.

Patent Document 6 discloses a negative electrode material for a lithium ion secondary battery, wherein a granular graphite is used as a core material, graphite in which flake graphite adheres to all or part of the surface of the core material, granular graphites and/or an gathering of flake graphites are mixed.

Patent Document 7 discloses a negative electrode material for a nonaqueous secondary battery, comprising a carbon material A having an aspect ratio being a ratio of the major diameter to the minor diameter of not more than 5; and a flake graphite B having an aspect ratio being a ratio of the major diameter to the minor diameter of not less than 6 and a 80% particle diameter (d80) of not less than 1.7 times the average particle diameter (d50) of the carbon material A.

### CITATION LIST

### Patent Literatures

Patent Document 1: JP 2000-340232 A
Patent Document 2: JP H04-190555 A
Patent Document 3: JP 2002-050346 A
Patent Document 4: JP H07-320740 A
Patent Document 5: JP 2012-129167 A
Patent Document 6: JP 2004-127723 A
Patent Document 7: JP 2012-216532 A

### SUMMARY OF THE INVENTION

### Problems to be Solved by the Invention

However, the materials described in Patent Documents 1 to 4 can meet requirements concerning electric capacity and midterm cycle characteristics at low current density when the battery is used for mobile application, hardly meet requirements concerning electric capacity and long-term cycle characteristics at large current density when the battery is used for a high current application. In the negative electrode described in Patent Document 5, gaps of the electrodes are decreased, which results in slower diffusion of an electrolytic solution during charge and discharge, and poor charging characteristics. The negative electrode material described in Patent Document 6 can have charging characteristics improved by the adhesion of flake particles to the granular core material, but has poor cycle characteristics. The negative electrode material of Patent Document 7 has poor cycle characteristics.

An object of the present invention is to provide a negative electrode active material useful for providing a secondary battery having high capacity and being excellent in charging rate characteristics at large current density and in capacity maintenance ratio after storage at high temperatures.

### Means for Solving the Problems

The present invention includes the following embodiments.

[1] A negative electrode active material for a secondary battery, which satisfies the following (1) to (5).
(1) The negative electrode active material comprises an artificial flake graphite A and an artificial massive (lump) graphite B.
(2) A ratio D_{50(A)}/D_{50(B)} of a 50% particle diameter D_{50(A)} of the artificial flake graphite A in a volume-based particle size distribution to a 50% particle diameter D_{50(B)} of the artificial lump graphite B in a volume-based particle size distribution is more than 0.6 and less than 1.0.
(3) The artificial flake graphite A has a surface roughness R of not less than 2.8 and not more than 5.1.
(4) The artificial lump graphite B has a surface roughness R of not less than 6.0 and not more than 9.0.
(5) A ratio B/(A+B) of a mass of the artificial lump graphite B to the total mass of the artificial flake graphite A and the artificial lump graphite B is not less than 0.03 and not more than 0.30.
[2] The negative electrode active material according to [1], wherein the artificial flake graphite A has Lc of more than 100 nm and less than 300 nm, and the artificial lump graphite B has Lc of more than 50 nm and less than 85 nm.
[3] The negative electrode active material according to [1] or [2], wherein the 50% particle diameter D_{50(A)} is not more than 20 μm, and the 50% particle diameter D_{50(B)} is not more than 35 μm.
[4] The negative electrode active material according to any one of [1] to [3], wherein the artificial flake graphite A has an aspect ratio of more than 1.50, and the artificial lump graphite B has an aspect ratio ranging from 1.00 to 1.50.
[5] The negative electrode active material according to any one of [1] to [4], wherein the artificial flake graphite A has I₍₁₁₀)/I₍₀₀₄₎ of not more than 0.10, and the artificial lump graphite B has I₍₁₁₀)/I₍₀₀₄₎ of not less than 0.30.
[6] The negative electrode active material according to any one of [1] to [5], wherein the artificial flake graphite A has a BET specific surface area ranging from 1.0 to 7.0 m²/g, and the artificial lump graphite B has a BET specific surface area ranging from 1.5 to 10.0 m²/g_{.}
[7] The negative electrode active material according to any one of [1] to [6], wherein the negative electrode active material has Lc of not less than 30 nm, I₍₁₁₀₎/I₍₀₀₄₎ ranging from 0.06 to 0.35, a BET specific surface area ranging from 1.6 to 10.0 m²/g, a surface roughness R ranging from 4.0 to 6.4, and a 50% particle diameter D₅₀ ranging from 8.0 to 30.0 μm in a volume-based particle size distribution.
[8] A method for producing a negative electrode active material for a secondary battery, which satisfies the following (1) to (5).
(1) The method comprises mixing an artificial flake graphite A and an artificial lump graphite B.
(2) The artificial flake graphite A has a surface roughness R of not less than 2.8 and not more than 5.1.
(3) The artificial lump graphite B has a surface roughness R of not less than 6.0 and not more than 9.0.
(4) A ratio D_{50(A)}/D_{50(B)} of 50% particle diameter D_{50(A)} of the artificial flake graphite A in a volume-based particle size distribution to 50% particle diameter D_{50(B)} of the artificial lump graphite B in a volume-based particle size distribution is more than 0.6 and less than 1.0.
(5) A ratio B/(A+B) of a mass of the artificial lump graphite B to the total mass of the artificial flake graphite A and the artificial lump graphite B is not less than 0.03 and not more than 0.30.
[9] The production method according to [8], wherein the artificial flake graphite A has Lc of more than 100 nm and less than 300 nm, and the artificial lump graphite B has Lc of more than 50 nm and less than 85 nm.
[10] The production method according to [8] or [9], wherein the 50% particle diameter D_{50(A)} is not more than 20 μm, and the 50% particle diameter D_{50(B)} is not more than 35 μm.
[11] The production method according to any one of [8] to [10], wherein the artificial flake graphite A has an aspect ratio of more than 1.50 and the artificial lump graphite B has an aspect ratio ranging from 1.00 to 1.50.
[12] The production method according to any one of [8] to [11], wherein the artificial flake graphite A has I₍₁₁₀₎/I₍₀₀₄₎ of not more than 0.10, and the artificial lump graphite B has I₍₁₁₀₎/I₍₀₀₄₎ of not less than 0.30.
[13] The production method according to any one of [8] to [12], wherein the artificial flake graphite A has a BET specific surface area ranging from 1.0 to 7.0 m²/g, and the flake artificial graphite B has a BET specific surface area ranging from 1.5 to 10.0 m²/g.
[14] A carbon material for a battery electrode, comprising the negative electrode active material for a secondary battery according to any one of [1] to [7].
[15] An electrode, comprising the negative electrode active material for a secondary battery according to any one of [1] to [7].
[16] A secondary battery, comprising the electrode according to [15].
[17] An all-solid secondary battery, comprising the electrode according to [15].

### Advantageous Effects of the Invention

The present invention can provide a negative electrode active material useful for providing a secondary battery having high capacity and being excellent in charge and discharge characteristics at large current density and in capacity maintenance ratio after storage at high temperatures.

### BRIEF DESCRIPTION OF THE DRAWINGS

FIG. 1 depicts an example of a cross-sectional image of an electrode in which the negative electrode active material of an embodiment of the present invention is used. Portions of artificial flake graphite A are enclosed by dotted lines. Portions of artificial lump graphite B are enclosed by solid lines.

### EMBODIMENTS FOR CARRYING OUT THE INVENTION

### (Negative Electrode Active Material for Secondary Battery)

The negative electrode active material according to an embodiment of the present invention comprises an artificial flake graphite A and an artificial lump graphite B.

### [Artificial Flake Graphite A]

The artificial flake graphite A to be used in the present invention is in the form of flake particles. In the present invention, the flake particles have a high aspect ratio, which is preferably more than 1.50. The artificial flake graphite A has an aspect ratio of more preferably not less than 1.55, and further preferably not less than 1.58.

Note that aspect ratio is measured by the following method, which involves photographing with an electron microscope, finding the x/y values of 20 particles within an arbitrarily selected area when the longest diameter of each particle is designated as x (μm), and the shortest diameter of the same is designated as y (μm), and then determining the average of the x/y values of 20 particles as aspect ratio.

The artificial flake graphite A to be used in the present invention has a crystal size in C axis direction Lc of preferably more than 100 nm and less than 300 nm, more preferably more than 120 nm and less than 270 nm, and further preferably more than 140 nm and less than 250 nm. The artificial flake graphite A having Lc within such a range significantly contributes to improvement in electric capacity of the relevant secondary battery.

Note that crystal size in C axis direction Lc can be calculated based on a peak derived from (002) as measured using powder X-ray diffraction (XRD). Measurement of Lc is more specifically described in Japan Society for the Promotion of Science, 117th committee literature, 117-71-A-1(1963), Japan Society for the Promotion of Science, 117th committee literature, 117-121-C-5(1972), or “Carbon”, 1963, No. 36, pp. 25-34.

The artificial flake graphite A has a 50% particle diameter D_{50(A)} of preferably not more than 20 μm, more preferably 0.5 μm to 20 μm, further preferably 3 μm to 18 μm, and most preferably 5 μm to 15 μm. 50% particle diameter D_{50(A)} can be determined from a volume-based particle size distribution obtained by dispersing graphite in a solvent, and then applying it to a laser diffraction-type particle-size-distribution measuring apparatus.

The artificial flake graphite A has a BET specific surface area (S_{BET}) of preferably 1.0 to 7.0 m²/g, more preferably 1.5 to 5.0 m²/g, and further preferably 2.0 to 3.0 m²/g. In the case of not less than 1.0 m²/g, an occurrence frequency of side reaction is reduced upon initial charge and discharge, and thus a battery having good initial coulombic efficiency can be obtained. In the case of not more than 7.0 m²/g, the occlusion/release reaction of lithium ions is not easily inhibited and thus a battery having good input-output characteristics can be obtained.

Note that BET specific surface area S_{BET} can be determined by a nitrogen gas adsorption method using a specific surface meter (for example, NOVA-1200 manufactured by YUASA Ionics Corporation).

The artificial flake graphite A has a surface roughness R of preferably 2.8 to 5.1, more preferably 3.0 to 4.8, and further preferably 3.0 to 4.0.

Note that surface roughness R is defined by the following formula.

R=S_{BET}/S_{D}

Wherein S_{D} can be calculated by the following formula based on the data of a particle size distribution obtained using a laser diffraction-type particle-size-distribution measuring apparatus (for example, MASTERSIZER manufactured by Malvern Panalytical).

$${S}_{D} = \frac{6}{ρ D} = \frac{6 \sum \frac{{V}_{i}}{{d}_{i}}}{ρ \sum {V}_{1}}$$

Wherein, Vᵢ denotes relative volume of particle diameter section i (average diameter dᵢ), ρ denotes particle density, and D denotes particle diameter.

The artificial flake graphite A has I₍₁₁₀₎/I₍₀₀₄₎ of preferably not more than 0.10, more preferably not more than 0.05, and further preferably not more than 0.03. When the artificial flake graphite A having I₍₁₁₀₎/I₍₀₀₄₎ of not more than 0.10 is mixed with the artificial lump graphite B, the density of the resulting electrode tends to be easily adjustable.

As the artificial flake graphite A to be used in the present invention, an artificial graphite having the predetermined values of physical properties may be selected from commercially available artificial graphite, or may be produced by graphitization of commercially available needle coke. For example, the artificial flake graphite A can be produced by burning needle coke, pulverizing and classifying the resultant so as to have a predetermined particle diameter, and then graphitizing the resultant at not lower than 2900° C. In this case, the artificial flake graphite A having predetermined values of physical properties can be produced by selecting needle coke in such a manner that the crystal structure and surface roughness are within predetermined ranges, and adjusting the temperature for graphitization. Among the artificial graphites, an artificial graphite comprising primary particles, obtained by pulverization and graphitization of coke as a raw material, have a solid core (filled core) structure, is excellent in cycle characteristics and high temperature storage characteristics.

### [Artificial Lump Graphite B]

Artificial lump graphite B to be used in the present invention is in the form of lump particles. In the present invention, lump particles are particles having an aspect ratio of nearly 1, or particles having an aspect ratio of preferably not less than 1.00 and not more than 1.50. Artificial lump graphite B has an aspect ratio of more preferably not less than 1.20 and not more than 1.45, and further preferably not less than 1.30 and not more than 1.43.

Artificial lump graphite B to be used in the present invention has a crystal size in C axis direction Lc of preferably more than 50 nm and less than 85 nm, more preferably more than 55 nm and less than 80 nm, and further preferably more than 60 nm and less than 80 nm. Artificial lump graphite B having Lc within the range significantly contributes to improvement in large current characteristics of the secondary battery.

Artificial lump graphite B has a 50% particle diameter D_{50(B)} of preferably not more than 35 μm, more preferably 0.5 μm to 35 μm, further preferably 5 μm to 30 μm, and most preferably 10 μm to 26 μm. A 50% particle diameter D_{50(B)} can be determined by the same method as for 50% particle diameter D_{50(A)}.

Artificial lump graphite B has a BET specific surface area (S_{BET}) of preferably 1.5 to 10.0 m²/g, further preferably 2.0 to 5.0 m²/g and most preferably 2.5 to 4.0 m²/g. In the case of not less than 1.5 m²/g, the side reaction upon initial charge and discharge is inhibited and thus a battery having good initial coulombic efficiency can be obtained. In the case of not more than 10.0 m²/g, the occlusion/release reaction of lithium ions is hardly inhibited, and thus a battery having good input-output characteristics can be obtained.

Artificial lump graphite B has a surface roughness

R of preferably 6.0 to 9.0, more preferably 6.5 to 8.5, and further preferably 6.8 to 8.2. The surface roughness R within the range can result in an increased square measure in contact with an electrolytic solution, smooth intercalation and deintercalation of lithium, and lowered reaction resistance of the battery.

Artificial lump graphite B has I₍₁₁₀₎/I₍₀₀₄₎ of preferably not less than 0.30, more preferably not less than 0.45, and further preferably not less than 0.55. Artificial lump graphite B having I₍₁₁₀₎/I₍₀₀₄₎ of not less than 0.30 leads to the suppression of orientation to an electrode current collector, so that Li intercalation can easily take place, and a battery having good input-output characteristics and suppressed expansion of the electrode is likely to be easily obtained.

As artificial lump graphite B to be used in the present invention, artificial graphite having predetermined physical properties may be selected from commercially available artificial graphite, or artificial lump graphite B may be produced by graphitization of commercially available shot coke. For example, artificial lump graphite B can be produced by burning shot coke, pulverizing and classifying the resultant in such a manner that the resultant has a predetermined particle diameter and aspect ratio, and then graphitizing the resultant at not lower than 2900° C. In this case, artificial lump graphite B having predetermined physical properties can be produced by selecting shot coke having a crystal structure and a surface roughness within predetermined ranges to adjust the graphitization temperature. Among artificial graphites, artificial graphite comprising primary particles, obtained by pulverization and graphitization of coke as a raw material, having a solid core structure, is excellent in cycle characteristics and high temperature storage characteristics.

In the negative electrode active material of the present invention, the ratio D_{50(A)}/D_{50(B)} of the 50% particle diameter D_{50(A)} of the artificial flake graphite A in a volume-based particle size distribution to the 50% particle diameter D_{50(B)} of the artificial lump graphite B in a volume-based particle size distribution is more than 0.6 and less than 1.0, preferably more than 0.65 and less than 0.90, and more preferably more than 0.65 and less than 0.70.

Artificial lump graphite B is circular or elliptical. When artificial lump graphite B and artificial flake graphite A are mixed at such a ratio D_{50(A)}/D_{50(B)} within the above range, the orientation direction of artificial flake graphite A will be random. This results in improved charging characteristics.

In the negative electrode active material of the present invention, a ratio B/(A+B) of the mass of artificial lump graphite B to the total mass of the artificial flake graphite A and the artificial lump graphite B is not less than 0.03 and not more than 0.30, and preferably not less than 0.05 and not more than 0.25. If the ratio B/(A+B) is within this range, the artificial flake graphite A significantly contributes to improvement in electric capacity and the artificial lump graphite B significantly contributes to improvement in large current characteristics.

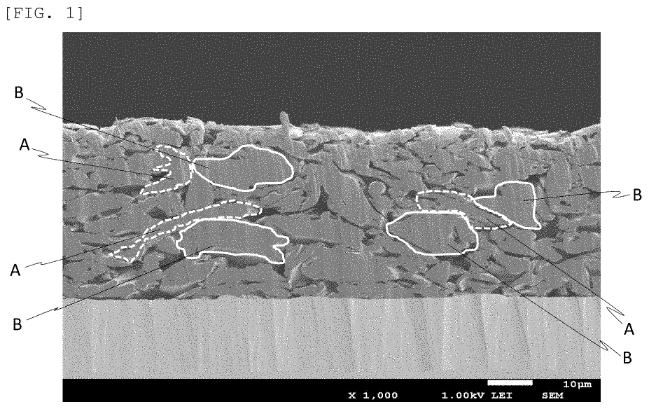

A negative electrode layer obtained using the negative electrode active material of the present invention composes an electrode structure, for example, as depicted in FIG. 1, in which the artificial flake graphite A (portions enclosed by dotted lines) leans against the artificial lump graphite B (portions enclosed by solid lines). The orientation of the artificial flake graphite A is lowered, resulting in improved charging rate characteristics.

The negative electrode active material of the present invention has I₍₁₁₀₎/I₍₀₀₄₎ ranging from preferably 0.06 to 0.35, more preferably 0.08 to 0.32, and further preferably 0.10 to 0.30. I₍₁₁₀₎/I₍₀₀₄₎ is a ratio of intensity of peak derived from (110) to intensity of peak derived from (004) as measured by X-ray diffraction. I₍₁₁₀₎/I₍₀₀₄₎ is an index of orientation. As the I₍₁₁₀₎/I₍₀₀₄₎ is lower, the orientation is higher, and as the I₍₁₁₀)/I₍₀₀₄₎ is higher, the orientation is lower.

Furthermore, the negative electrode active material of the present invention has I₍₁₁₀₎/I₍₀₀₄₎ higher than the arithmetic mean value of I₍₁₁₀₎/I₍₀₀₄₎ of the artificial flake graphite A and I₍₁₁₀₎/I₍₀₀₄₎ of the artificial lump graphite B.

The negative electrode active material of the present invention has Lc of preferably not less than 30 nm, more preferably not less than 50 nm, and further preferably not less than 70 nm. The higher the Lc, the higher the electric capacity to be stored in the mixed negative electrode active material.

The negative electrode active material of the present invention has a BET specific surface area having a lower limit of preferably 1.6 m²/g, more preferably 1.8 m²/g, and further preferably 2.0 m²/g, and an upper limit of preferably 10.0 m²/g, more preferably 5.0 m²/g, and further preferably 3.0 m²/g. When the negative electrode active material has a BET specific surface area of not less than 1.6 m²/g, the occlusion/release reaction of lithium ions is not easily inhibited and thus a battery excellent in input-output characteristics can be obtained. When the negative electrode active material has a BET specific surface area of not more than 10.0 m²/g, side reactions upon initial charge and discharge are inhibited and a battery having good initial coulombic efficiency can be obtained.

The negative electrode active material of the present invention has a surface roughness R having a lower limit of preferably 4.0, more preferably 4.1, and further preferably 4.2, and an upper limit of preferably 6.4, more preferably 6.0, and further preferably 5.0. When the negative electrode active material has a surface roughness R of not less than 4.0, the contact area that the negative electrode active material comes into contact with an electrolytic solution is large, lithium is smoothly intercalated and deintercalated, and thus the obtained battery tends to have low reaction resistance. When the negative electrode active material has a surface roughness R of not more than 6.4, side reactions are inhibited and thus the initial efficiency tends to be high.

A 50% particle diameter D₅₀ of the negative electrode active material of the present invention in a volume-based particle size distribution has a lower limit of preferably 8.0 μm, more preferably 10.0 μm, and further preferably 12.0 μm, and an upper limit of preferably 30.0 μm, more preferably 28.0 μm, and further preferably 25.0 μm. When the negative electrode active material has a 50% particle diameter D₅₀ of not less than 8.0 μm, the side reaction upon initial charge and discharge is inhibited, and thus a battery having good initial coulombic efficiency tends to be easily obtained. When the negative electrode active material has a 50% particle diameter D₅₀ of not more than 30.0 μm, the occlusion/release reaction of lithium ions is not easily inhibited and a battery excellent in input-output characteristics tends to be easily obtained.

### (Method for Producing Negative Electrode Active Material for Secondary Battery)

A method for producing a negative electrode active material according to an embodiment of the present invention comprises mixing an artificial flake graphite A and an artificial lump graphite B, having the above physical properties, at a mass ratio B/(A+B) within the above range. The mixing is performed until the artificial flake graphite A and the artificial lump graphite B reach a homogeneous state. A commercially available blender, agitator, or mixer can be used for the mixing. Examples of an apparatus for mixing can include a V type mixer, W type mixer, a ribbon mixer, a one blade mixer, and a multipurpose mixer.

### (Carbon Material for Battery Electrode)

The carbon material for a battery electrode according to an embodiment of the present invention comprises the negative electrode active material of the present invention. The carbon material for a battery electrode of the present invention may comprise a mixture of the negative electrode active material of the present invention and another material for an electrode, and preferably comprises only the negative electrode active material of the present invention. A secondary battery obtained using the carbon material for a battery electrode of the present invention exhibits high capacity, high coulomb efficiency, and improved charge and discharge rate and lowered direct current resistance while maintaining good capacity retaining characteristics after storage at high temperatures.

### (Paste or Slurry for Electrode)

The paste or slurry for an electrode in a preferred embodiment of the present invention comprises the carbon material for a battery electrode of the present invention and a binder. The paste or slurry for an electrode can be obtained by kneading the carbon material for a battery electrode of the present invention, a binder and a solvent.

Examples of the binder that can be used for paste or slurry for an electrode can include known binders, for example, fluorine-based polymers such as polyvinylidene fluoride and polytetrafluoroethylene, and rubber-based binders such as SBR (styrene-butadiene rubber).

An amount of the binder can be appropriately determined depending on a coating method to be employed. For example, the amount of the binder preferably ranges from 1 to 30 parts by mass relative 100 parts by mass of the carbon material for a battery electrode of the present invention.

A solvent that can be used for paste or slurry for an electrode can be appropriately selected depending on the type of a binder. For example, in the case of a fluorine-based polymer, toluene, N-methylpyrrolidone, and the like can be used. In the case of SBR, water and the like can be used. Other examples of the solvent can include dimethylformamide and isopropanol. In the case of a binder for which water is used as a solvent, a thickener is preferably used in combination therewith. An amount of the solvent can be appropriately determined in such a manner that it has viscosity facilitating application to a current collector.

A known device such as a ribbon mixer, a screw-type kneader, a Spartan ryuzer, a loedige mixer, a planetary mixer, or a universal mixer may be used for kneading. Paste or slurry for an electrode can be formed into a shape such as a sheet, a pellet, or the like.

### (Electrode)

The electrode in a preferred embodiment of the present invention comprises the carbon material for a battery electrode of the present invention and the above binder. The electrode is obtained, for example, by applying the paste or slurry for an electrode onto a current collector, followed by drying and pressing.

Examples of the current collector can include foils and meshes of aluminium, nickel, copper, and stainless steel. The coating thickness of paste or slurry is usually 50 to 200 μm. Excessively thick coating can make a standardized battery case impossible to house a negative electrode. A method for applying paste or slurry is not particularly limited and examples thereof can include a method that involves applying with a doctor blade or a bar coater, and then shaping with a roll pressing or the like.

Examples of pressing can include a roll pressing, and a plate pressing. Pressure for pressing preferably ranges from about 1 to 3 t/cm². In general, battery capacity per volume tends to increase as electrode density increases. However, in general, excessively high electrode density tends to result in decreased cycle characteristics. When paste for an electrode in a preferred embodiment of the present invention is used, a decrease in cycle characteristics is small even with a high level of electrode density, and thus an electrode with high electrode density can be obtained. The maximum value of electrode density obtained using the paste for an electrode generally ranges from 1.7 to 1.9 g/cm³. The thus obtained electrode is suitable as a negative electrode for a battery, and particularly as a negative electrode for a secondary battery.

(6) Battery, Secondary Battery, and all-Solid Secondary Battery

The electrode can be incorporated as a constituent element (preferably negative electrode) into a battery, a secondary battery or an all-solid secondary battery.

A battery or a secondary battery in a preferred embodiment of the present invention is as described below using a lithium ion secondary battery as a specific example. A lithium ion secondary battery has a structure in which a positive electrode and a negative electrode are immersed in an electrolytic solution or an electrolyte. As such a negative electrode, the electrode in a preferred embodiment of the present invention is employed.

A known positive electrode active material can be employed for a positive electrode of a lithium ion secondary battery. For example, a lithium-containing transition metal oxide can be employed, and specifically a compound, which is an oxide containing mainly at least one of transition metal element selected from preferably Ti, V, Cr, Mn, Fe, Co, Ni, Mo and W and lithium, and has a molar ratio of lithium and the transition metal element ranging from 0.3 to 2.2, can be employed.

In a lithium ion secondary battery, a separator can be provided between a positive electrode and a negative electrode. Examples of the separator can include a non-woven fabric, cloth, and a microporous film or combinations thereof, each comprising polyolefin such as polyethylene or polypropylene as a main component.

As electrolytic solutions and electrolytes, known organic electrolytic solutions, inorganic solid electrolytes, and polymer solid electrolytes can be used.

### EXAMPLES

Examples of the present invention are shown below and the present invention is more specifically described. These Examples are only illustrations for explanation and the present invention is not limited to these Examples. In Examples and Comparative examples, Lc, D₅₀, surface roughness R, BET specific surface area, aspect ratio, and the like were measured by the above-mentioned methods. Note that D₅₀ was measured using MASTERSIZER manufactured by Malvern Panalytical Ltd. BET specific surface area was measured using NOVA-1200 manufactured by YUASA Ionics Corporation. Furthermore, battery characteristics were measured by the following method.

<I₍₁₁₀₎/I₍₀₀₄₎>

A sample plate made of glass (plate window: 18×20 mm, depth: 0.2 mm) was filled with a carbon powder sample, and then subjected to XRD measurement under the following conditions.

XRD apparatus: SmartLab manufactured by Rigaku

X-ray type: Cu-Kα ray

Kβ-ray removal method: Ni filter

X-ray output: 45 kV, 200 mA

Measurement range: 5.0 to 10.0 deg.

Scan speed: 10.0 deg./min.

The thus obtained waveform was subjected to smoothing, background subtraction, and Kα2 removal, thereby performing profile fitting. The intensity ratio I₍₁₁₀₎/I₍₀₀₄₎ as an index of orientation was calculated from the thus obtained peak intensity I₍₀₀₄₎ of (004) plane and peak intensity I₍₁₁₀₎ of (110) plane. Note that the highest intensity was selected as the peak of each plane from the values within the following ranges.

(004) plane: 54.0 to 55.0 deg.

(110) plane: 76.5 to 78.0 deg

### 1. Method for Evaluating Coin Battery

### a) Preparation of Paste:

To 96.5 parts by mass of the negative electrode active material, 24.0 parts by mass of Polysol (registered trademark) manufactured by SHOWA DENKO K. K., was added, and then the mixture was kneaded using a planetary mixer, thereby preparing a main stock solution.

### b) Preparation of Electrode:

Water was added to the main stock solution to adjust viscosity, and then the adjusted solution was coated on a highly pure copper foil using a doctor blade in such a manner that the thickness was 150 μm. The resultant was subjected to vacuum drying at 70° C. for 1 hour, and then punched out to obtain an electrode piece each having a size of 16=cp. The electrode pieces was sandwiched between pressing plates made of super steel, and then pressed in such a manner that pressure applied to the electrode ranged from about 1×10² to 3×10² N/mm² (1×10³ to 3×10³ kg/cm²). Subsequently, the resultant was subjected to vacuum drying at 120° C. for 12 hours, thereby obtaining an electrode for evaluation.

### c) Preparation of Battery:

A counter electrode lithium cell was prepared as described below. Note that the following procedures were performed under a dry argon atmosphere at a dew point of not higher than −80° C.

In a coin cell with a screwed-type lid made of polypropylene (inside diameter: about 18 mm), the electrode for evaluation prepared in b) above, a separator (Microporous Film made of polypropylene (Celgard 2400)) and a metallic lithium foil were piled in this order. The following electrolytic solution was poured onto the resultant, thereby obtaining a test cell.

### d) Electrolytic Solution:

LiPF₆ was dissolved as an electrolyte at 1 mol/liter in a mixed solvent of 8 parts by mass of EC (ethylene carbonate) and 12 parts by mass of DEC (diethyl carbonate).

### e) Test for Determining Initial Efficiency:

First, CC (constant current) charging was performed from rest potential to 0.002 V at 0.2 mA/cm² (0.05 C). After the voltage reached 0.002 V, CV (constant voltage) charging was performed at 0.002 V. At the time when the current value decreased to 25.4 pA, the charging was stopped. Next, constant current discharging was performed at current density of 0.2 mA/cm² (0.05 C) until the voltage reached 1.5 V.

These charging and discharging were performed in a thermostatic chamber set at 25° C. Initial efficiency was calculated from the ratio of discharge capacity and charge capacity.

### f) Test for Determining Electric Capacity and Large Current Rate Characteristics:

First, CC (constant current) charging was performed from rest potential to 0.002 V at 0.2 mA/cm² (0.05 C). After the voltage reached 0.002 V, CV (constant voltage) charging was performed with 0.002 V. At the time when the current value decreased to 25.4 Δ, the charging was stopped. Next, constant current discharging was performed at current density of 0.2 mA/cm² (0.05 C) until the voltage reached 1.5 V.

These charging and discharging were performed in a thermostatic chamber set at 25° C.

Electric capacity was calculated by dividing charged electric quantity at 0.2 mA/cm² (0.05 C) by the amount of the active material per unit area.

Charging and discharging were performed in the same manner as described above except that CC (constant current) charging was performed at 2.0 mA/cm² (0.5 C) or 3.2 mA/cm² (0.8 C). The charged electric quantity at 2.0 mA/cm² (0.5 C) or 3.2 mA/cm² (0.8 C) was divided by that at 0.2 mA/cm² (0.05C), thereby calculating large current rate characteristics.

### 2. Method for Evaluation of Laminate Cell Battery

### a) Pressing of Negative Electrode

The electrode for evaluation prepared in 1 above was pressed with an uniaxial press machine in such a manner that electrode density after about 18 hours was 1.70 g/cm³, thereby obtaining a negative electrode. After pressing, the negative electrode was subjected to vacuum drying at 70° C. for 1 hour.

### b) Preparation of Positive Electrode

97.5 parts by mass of lithium cobaltite (mean particle diameter: 5 μm) as a positive electrode active material, 0.5 part by mass of vapor grown carbon fiber (VGCF (registered trademark)-H manufactured by SHOWA DENKO K.K.), 2.0 parts by mass of carbon black (C45 manufactured by Imerys G.C. Japan), and 3.0 parts by mass of polyvinylidene fluoride (PVDF) were dispersed in N-methylpyrrolidone, thereby obtaining paste. The paste was applied in a coating amount of 19.2 mg/cm² onto an aluminium foil, thereby obtaining a positive electrode plate. The positive electrode plate was subjected to vacuum drying at 70° C. for 1 hour. Next, the positive electrode plate was pressed using a roll press machine in such a manner that the electrode density was 3.55 g/cm³, thereby obtaining a positive electrode.

### c) Preparation of Battery

With the use of the negative electrode prepared in 2. a) above, the positive electrode prepared in 2. b), and a separator made of polypropylene, a monolayer laminate cell was prepared. An electrolytic solution used herein was prepared by dissolving LiPF₆ at 1 mol/L in a solvent prepared by mixing ethyl carbonate, ethyl methyl carbonate, and vinylene carbonate at a volume ratio of 30:70:1.)

Measurement of the Capacity of Two-Electrode Cell:

The cell was charged at 0.2 C (0.2 C=0.25 mA/cm²) in CC, CV modes under conditions of upper limit voltage of 4.15 V, and cutoff current value of 2.5 mA, followed by discharge at 0.2 C in a CC mode where the lower limit voltage was 2.8 V. The above procedure was repeated 4 times in total, and thus the fourth discharge capacity was determined to be reference capacity of the two-electrode cell. The test was conducted within a thermostatic chamber set at 25° C.

### d) Measurement of Direct Current Resistance

To the monolayer laminate cell prepared in 2. c) above, different current values were applied in 50% state-of-charge (SOC). Voltage changes were plotted according to the Ohm's law, thereby calculating the value of direct current resistance.

### e) Measurement of High Temperature Storage Characteristics

The monolayer laminate cell prepared in 2. c) above was charged at 0.2 C (0.2C=0.25 mA/cm²) in CC, CV modes under the conditions of the upper-limit voltage of 4.15 V and the cutoff current value of 2.5 mA. The charged cell was left to stand for 4 weeks in a thermostatic chamber set at 60° C., followed by discharge at 0.2 C in a CC mode where the lower-limit voltage was 2.8 V, and measurement of the capacity. The capacity found at this time was designated as the storage capacity. The storage capacity was divided by reference capacity, thereby calculating high-temperature storage capacity maintenance rate (%).

### (Artificial Graphite 1)

Needle coke was burned at 1100° C., the resultant was pulverized using an ACM pulverizer (manufactured by Hosokawa Micron Corporation) for 20 minutes and then classified, followed by graphitization at 3300° C. for production of artificial graphite 1. The values of Physical Properties are Shown in Table 1.

(Artificial graphite 2)

Shot coke was burned at 1000° C., the resultant was pulverized using an ACM pulverizer for 15 minutes and then classified, followed by graphitization at 3000° C. for production of artificial graphite 2. The values of physical properties are shown in Table 1.

### (Artificial Graphite 3)

Needle coke was burned at 1000° C., the resultant was pulverized using an ACM pulverizer for 20 minutes and then classified, followed by graphitization at 3000° C. for production of artificial graphite 3. The values of physical properties are shown in Table 1.

### (Artificial Graphite 4)

Shot coke was burned at 1000° C., the resultant was pulverized using a jet mill pulverizer for 20 minutes and then classified, followed by graphitization at 3000° C. for production of artificial graphite 4. The values of physical properties are shown in Table 1.

### (Artificial Graphite 5)

Needle coke was burned at 1100° C., the resultant was pulverized using an ACM pulverizer for 20 minutes and then classified, followed by graphitization 3100° C. for production of artificial graphite 5. The values of physical properties are shown in Table 1.

### (Artificial Graphite 6)

Needle coke was burned at 1000° C., the resultant was pulverized using an ACM pulverizer for 10 minutes and then classified, followed by graphitization at 2800° C. for production of artificial graphite 6. The values of physical properties are shown in Table 1.

### (Carbon Material 1)

Shot coke was burned at 1300° C., the resultant was pulverized using an ACM pulverizer for 20 minutes and then classified for production of carbon material 1. The values of physical properties are shown in Table 1.

### (Composite Graphite 1)

Shot coke was mixed with pitch (softening point: 200° C.), the mixture was burned at 1000° C., the resultant was pulverized using an ACM pulverizer for 20 minutes and then classified, and then graphitization was performed at 3000° C. for production of composite graphite 1. The values of physical properties are shown in Table 1.

TABLE 1

| | | | | | | |
|---|---|---|---|---|---|---|
| | | BET | | | | |
| | | Specific | | | | |
| | | Surface | | Surface | | |
| | Lc | Area | D₅₀ | roughness | Aspect | I ₍₁₁₀₎/ |
| shape | [nm] | [m²/g] | [μm] | R | ratio | I ₍₀₀₄₎ |

Material A

| | | | | | | | |
|---|---|---|---|---|---|---|---|
| Artificial | Scale | 189 | 2.1 | 15 | 3.90 | 1.59 | 0.01 |
| graphite 1 | | | | | | | |
| Artificial | Scale | 141 | 2.1 | 13 | 3.85 | 1.53 | 0.15 |
| graphite 3 | | | | | | | |
| Artificial | Scale | 176 | 1.3 | 14 | 2.59 | 1.62 | 0.01 |
| graphite 5 | | | | | | | |

Material B

| | | | | | | | |
|---|---|---|---|---|---|---|---|
| Artificial | Scale | 78 | 2.6 | 23 | 6.46 | 1.78 | 0.01 |
| graphite 6 | | | | | | | |
| Artificial | Lump | 78 | 2.5 | 22 | 7.34 | 1.41 | 0.60 |
| graphite 2 | | | | | | | |
| Artificial | Lump | 79 | 4.0 | 5 | 4.00 | 1.47 | 0.40 |
| graphite 4 | | | | | | | |
| Carbon | Lump | 5 | 3.0 | 16 | 6.51 | 1.48 | — |
| material 1 | | | | | | | |
| Composite | Lump | 74 | 2.3 | 22 | 2.28 | 1.45 | 0.60 |
| graphite 1 | | | | | | | |

### Example 1

Artificial graphite 1 as material A and artificial graphite 2 as material B were mixed using a V type mixer for 15 minutes in such a manner that the mass ratio B/(A+B) was 0.05, thereby obtaining a negative electrode active material. The values of physical properties and battery characteristics of the negative electrode active material are shown in Table 2 and Table 3.

Examples 2 and 3 and Comparative examples 1 to 21 Negative electrode active materials were obtained in the same manner as in Example 1 except that material A and material B were used at mass ratios shown in Table 2. The values of physical properties and battery characteristics of the negative electrode active materials are shown in Table 2 and Table 3.

TABLE 2

| | | | | | Properties of Negative | | | | |
|---|---|---|---|---|---|---|---|---|---|
| | | | | | electrode active material | | | | |
| | | | Mass | | | BET | | | |
| | | | Ratio | | | Specific | | | |
| | | | B/ | | | Surface | | | Surface |
| | Material | Material | (A + | D_{50(A)}/ | Lc | Area | D₅₀ | I ₍₁₁₀₎/ | roughness |
| | A | B | B) | D_{50(B)} | [nm] | [m²/g] | [μm] | I ₍₀₀₄₎ | R |
| Ex.1 | Artificial | Artificial | 0.05 | 0.68 | 153 | 2.1 | 15.1 | 0.10 | 4.2 |
| | graphite 1 | graphite 2 | | | | | | | |
| Ex.2 | Artificial | Artificial | 0.15 | 0.68 | 133 | 2.1 | 15.5 | 0.20 | 4.4 |
| | graphite 1 | graphite 2 | | | | | | | |
| Ex.3 | Artificial | Artificial | 0.25 | 0.68 | 133 | 2.1 | 15.7 | 0.30 | 4.8 |
| | graphite 1 | graphite 2 | | | | | | | |
| Comp.Ex.1 | Artificial | — | 0.00 | — | 189 | 2.1 | 15.0 | 0.01 | 3.9 |
| | graphite 1 | | | | | | | | |
| Comp.Ex.2 | — | Artificial | 1.00 | — | 78.1 | 2.5 | 22.0 | 0.60 | 7.3 |
| | | graphite 2 | | | | | | | |
| Comp.Ex.3 | Artificial | — | 0.00 | — | 141 | 2.1 | 13.0 | 0.15 | 3.9 |
| | graphite 3 | | | | | | | | |
| Comp.Ex.4 | — | Artificial | 1.00 | — | 79 | 4.0 | 5.0 | 0.40 | 4.0 |
| | | graphite 4 | | | | | | | |
| Comp.Ex.5 | Artificial | — | 0.00 | — | 176 | 1.3 | 14.0 | 0.01 | 2.6 |
| | graphite 5 | | | | | | | | |
| Comp.Ex.6 | — | Artificial | 1.00 | — | 78 | 2.6 | 23.0 | 0.01 | 6.5 |
| | | graphite 6 | | | | | | | |
| Comp.Ex.7 | — | Carbon | 1.00 | — | 5 | 3.0 | 16.0 | — | 6.5 |
| | | material 1 | | | | | | | |
| Comp.Ex.8 | — | Composite | 1.00 | — | 74 | 2.3 | 22.0 | 0.60 | 2.3 |
| | | graphite 1 | | | | | | | |
| Comp.Ex.9 | Artificial | Artificial | 0.10 | 0.59 | 135 | 2.1 | 13.3 | 0.40 | 4.2 |
| | graphite 3 | graphite 2 | | | | | | | |
| Comp.Ex.10 | Artificial | Artificial | 0.15 | 0.59 | 139 | 2.1 | 13.5 | 0.45 | 4.4 |
| | graphite 3 | graphite 2 | | | | | | | |
| Comp.Ex.11 | Artificial | Artificial | 0.10 | 3.00 | 179 | 2.3 | 13.4 | 0.01 | 3.9 |
| | graphite 1 | graphite 4 | | | | | | | |
| Comp.Ex.12 | Artificial | Artificial | 0.20 | 3.00 | 176 | 2.6 | 12.8 | 0.03 | 3.9 |
| | graphite 1 | graphite 4 | | | | | | | |
| Comp.Ex.13 | Artificial | Artificial | 0.30 | 3.00 | 150 | 2.9 | 12.2 | 0.05 | 3.9 |
| | graphite 1 | graphite 4 | | | | | | | |
| Comp.Ex.14 | Artificial | Artificial | 0.10 | 0.63 | 135 | 1.4 | 15.3 | 0.15 | 3.1 |
| | graphite 5 | graphite 2 | | | | | | | |
| Comp.Ex.15 | Artificial | Artificial | 0.20 | 0.63 | 115 | 1.5 | 15.7 | 0.25 | 3.5 |
| | graphite 5 | graphite 2 | | | | | | | |
| Comp.Ex.16 | Artificial | Artificial | 0.10 | 0.65 | 143 | 2.2 | 15.1 | 0.01 | 4.2 |
| | graphite 1 | graphite 6 | | | | | | | |
| Comp.Ex.17 | Artificial | Artificial | 0.20 | 0.65 | 133 | 2.3 | 15.6 | 0.01 | 4.4 |
| | graphite 1 | graphite 6 | | | | | | | |
| Comp.Ex.18 | Artificial | Carbon | 0.10 | 0.94 | 83 | 2.3 | 15.2 | 0.01 | 4.2 |
| | graphite 1 | material 1 | | | | | | | |
| Comp.Ex.19 | Artificial | Carbon | 0.20 | 0.94 | 63 | 2.4 | 15.3 | 0.01 | 4.4 |
| | graphite 1 | material 1 | | | | | | | |
| Comp.Ex.20 | Artificial | Composite | 0.10 | 0.68 | 141 | 2.1 | 15.5 | 0.07 | 3.7 |
| | graphite 1 | graphite 1 | | | | | | | |
| Comp.Ex.21 | Artificial | Composite | 0.20 | 0.68 | 130 | 2.1 | 15.6 | 0.13 | 3.6 |
| | graphite 1 | graphite 1 | | | | | | | |

TABLE 3

| | Battery characteristics | | | | | |
|---|---|---|---|---|---|---|
| | | | Large | Large | | High- |
| | | | current | current | | temperature |
| | | | rate | rate | Direct | storage |
| | Initial | Electric | character- | character- | current | capacity |
| | Efficiency | capacity | istics | istics | resistance | maintenance |
| | [%] | [mAh/g] | 0.5 C [%] | 0.8 C [%] | [Ω] | ratio [%] |
| Ex.1 | 92.6 | 355.5 | 58.8 | 47.9 | 0.90 | 70.3 |
| Ex.2 | 92.1 | 354.9 | 63.9 | 52.2 | 0.88 | 69.7 |
| Ex.3 | 91.9 | 350.5 | 64.8 | 51.4 | 0.88 | 70.2 |
| Comp.Ex.1 | 93.4 | 363.3 | 55.2 | 34.4 | 0.97 | 68.5 |
| Comp.Ex.2 | 90.5 | 330.5 | 62.3 | 36.5 | 0.94 | 71.1 |
| Comp.Ex.3 | 91.5 | 349.7 | 53.8 | 33.5 | 0.94 | 71.1 |
| Comp.Ex.4 | 92.6 | 331.0 | 69.6 | 49.9 | 0.68 | 73.5 |
| Comp.Ex.5 | 93.0 | 356.5 | 52.1 | 30.3 | 0.98 | 67.7 |
| Comp.Ex.6 | 90.4 | 330.6 | 61.3 | 50.4 | 0.94 | 70.2 |
| Comp.Ex.7 | 84.5 | 236.6 | 63.7 | 43.5 | 0.88 | 64.8 |
| Comp.Ex.8 | 90.8 | 330.9 | 64.1 | 53.1 | 0.92 | 71.4 |
| Comp.Ex.9 | 91.4 | 343.7 | 57.3 | 37.5 | 0.93 | 69.6 |
| Comp.Ex.10 | 90.8 | 348.0 | 56.4 | 36.8 | 0.94 | 69.9 |
| Comp.Ex.11 | 92.9 | 352.1 | 63.3 | 43.3 | 0.90 | 70.9 |
| Comp.Ex.12 | 91.5 | 351.5 | 61.4 | 41.6 | 0.92 | 71.2 |
| Comp.Ex.13 | 91.4 | 348.1 | 62.3 | 42.6 | 0.91 | 71.2 |
| Comp.Ex.14 | 92.9 | 352.1 | 48.4 | 28.5 | 1.01 | 67.7 |
| Comp.Ex.15 | 91.4 | 351.5 | 47.5 | 27.9 | 1.02 | 67.6 |
| Comp.Ex.16 | 91.3 | 358.3 | 56.5 | 32.4 | 0.94 | 69.3 |
| Comp.Ex.17 | 90.9 | 354.0 | 55.2 | 31.8 | 0.95 | 69.3 |
| Comp.Ex.18 | 90.4 | 348.9 | 55.2 | 35.3 | 0.93 | 66.9 |
| Comp.Ex.19 | 89.6 | 335.9 | 54.7 | 35.4 | 0.93 | 65.8 |
| Comp.Ex.20 | 92.7 | 355.0 | 55.8 | 37.9 | 0.92 | 70.1 |
| Comp.Ex.21 | 91.7 | 349.9 | 54.9 | 36.2 | 0.93 | 69.4 |

As shown in Table 2 and Table 3, secondary batteries (Examples 1 to 3) comprising electrodes used therein comprising the negative electrode active materials of the present invention had large current rate characteristics and electric capacity better than those comprising negative electrode active materials obtained in Comparative examples 1 to 21.

A secondary battery comprising the negative electrode active material of the present invention is small and light-weight, and has high discharge capacity, and excellent large current characteristics, and thus can be suitably used in wide-ranging applications such as cellular phones, portable electronic apparatuses, electric tools, electric cars, and hybrid vehicles.

### EXPLANATION OF SYMBOLS

A: artificial flake graphite
B: artificial lump graphite

1. A negative electrode active material for a secondary battery, which satisfies the following (1) to (6):
(1) the negative electrode active material comprises an artificial flake graphite A and an artificial lump graphite B;
(2) a ratio D_{50(A)}/D_{50(B)} of a 50% particle diameter D_{50(A)} of the artificial flake graphite A in a volume-based particle size distribution to a 50% particle diameter D_{50(B)} of the artificial lump graphite B in a volume-based particle size distribution is more than 0.6 and less than 1.0;
(3) the artificial flake graphite A has a surface roughness R of not less than 2.8 and not more than 5.1;
(4) the artificial lump graphite B has a surface roughness R of not less than 6.0 and not more than 9.0;
(5) a ratio B/(A+B) of a mass of the artificial lump graphite B to the total mass of the artificial flake graphite A and the artificial lump graphite B is not less than 0.03 and not more than 0.30; and
the 50% particle diameter D_{50(A)} is not more than 20 μm, and the 50% particle diameter D_{50(B)} is not more than 35 μm.

2. The negative electrode active material according to claim 1, wherein the artificial flake graphite A has Lc of more than 100 nm and less than 300 nm, and the artificial lump graphite B has Lc of more than 50 nm and less than 85 nm.

3. (canceled)

4. The negative electrode active material according to claim 1, wherein the artificial flake graphite A has an aspect ratio of more than 1.50, and the artificial lump graphite B has an aspect ratio of 1.00 to 1.50.

5. The negative electrode active material according to claim 1, wherein the artificial flake graphite A has I₍₁₁₀₎/I₍₀₀₄₎ of not more than 0.10, and the artificial lump graphite B has I₍₁₁₀₎/I₍₀₀₄₎ of not less than 0.30.

6. The negative electrode active material according to claim 1, wherein the artificial flake graphite A has a BET specific surface area of 1.0 to 7.0 m²/g, and the artificial lump graphite B has a BET specific surface area of 1.5 to 10.0 m²/g.

7. The A negative electrode active material for a secondary battery, which satisfies the following (1) to (5) and (7):
(1) the negative electrode active material comprises an artificial flake graphite A and an artificial lump graphite B,
(2) a ratio D_{50(A)}/D_{50(B)} of a 50% particle diameter D_{50(A)} of the artificial flake graphite A in a volume-based particle size distribution to a 50% particle diameter D_{50(B)} of the artificial lump graphite B in a volume-based particle size distribution is more than 0.6 and less than 1.0;
(3) the artificial flake graphite A has a surface roughness R of not less than 2.8 and not more than 5.1;
(4) the artificial lump graphite B has a surface roughness R of not less than 6.0 and not more than 9.0;
(5) a ratio B/(A+B) of a mass of the artificial lump graphite B to the total mass of the artificial flake graphite A and the artificial lump graphite B is not less than 0.03 and not more than 0.30; and
(7) the negative electrode active material has Lc of not less than 30 nm, I₍₁₁₀₎/I₍₀₀₄₎ of 0.06 to 0.35, a BET specific surface area of 1.6 to 10.0 m²/g, a surface roughness R of 4.0 to 6.4, and a 50% particle diameter D₅₀ of 8.0 to 30.0 μm in a volume-based particle size distribution.

8. A method for producing a negative electrode active material for a secondary battery, which satisfies the following (1) to (6):
(1) the method comprises mixing an artificial flake graphite A and an artificial lump graphite B;
(2) the artificial flake graphite A has a surface roughness R of not less than 2.8 and not more than 5.1;
(3) the artificial lump graphite B has a surface roughness R of not less than 6.0 and not more than 9.0;
(4) a ratio D_{50(A)}/D_{50(B)} of 50% particle diameter D_{50(A)} of the artificial flake graphite A in a volume-based particle size distribution to 50% particle diameter D_{50(B)} of the artificial lump graphite B in a volume-based particle size distribution is more than 0.6 and less than 1.0;
(5) a ratio B/(A+B) of a mass of the artificial lump graphite B to the total mass of the artificial flake graphite A and the artificial lump graphite B is not less than 0.03 and not more than 0.30; and
the 50% particle diameter D_{50(A)} is not more than 20 and the 50% particle diameter D_{50(B)} is not more than 35 μm.

9. The production method according to claim 8, wherein the artificial flake graphite A has Lc of more than 100 nm and less than 300 nm, and the artificial lump graphite B has Lc of more than 50 nm and less than 85 nm.

10. The production method according to claim 8, wherein the 50% particle diameter D_{50(A)} is not more than 20 and the 50% particle diameter D_{50(B)} is not more than 35 μm.

11. The production method according to claim 8, wherein the artificial flake graphite A has an aspect ratio of more than 1.50 and the artificial lump graphite B has an aspect ratio of 1.00 to 1.50.

12. The production method according to claim 8, wherein the artificial flake graphite A has I₍₁₁₀₎/I₍₀₀₄₎ of not more than 0.10, and the artificial lump graphite B has I₍₁₁₀₎/I₍₀₀₄₎ of not less than 0.30.

13. The production method according to claim 8, wherein the artificial flake graphite A has a BET specific surface area of 1.0 to 7.0 m²/g, and the flake artificial graphite B has a BET specific surface area of 1.5 to 10.0 m²/g.

14. A carbon material for a battery electrode, comprising the negative electrode active material for a secondary battery according to claim 1.

15. An electrode, comprising the negative electrode active material for a secondary battery according to claim 1.

16. A secondary battery, comprising the electrode according to claim 15.
